(19) United States
(12) Patent Application Publication
(10) Pub. No.: US 2015/0214792 A1
(43) Pub. Date: Jul. 30, 2015

(54) SPINDLE MOTOR AND RECORDING DISK DRIVING DEVICE INCLUDING THE SAME

(71) Applicant: SAMSUNG ELECTRO-MECHANICS CO., LTD., Suwon-Si (KR)

(72) Inventor: Han Byul KIM, Suwon-Si (KR)

(73) Assignee: SAMSUNG ELECTRO-MECHANICS CO., LTD., Suwon-Si (KR)

(21) Appl. No.: 14/597,222

(22) Filed: Jan. 15, 2015

(30) Foreign Application Priority Data
Jan. 28, 2014 (KR) 10-2014-0010056

(51) Int. Cl. H02K 1/18; G11B 19/20

(52) U.S. Cl. CPC H02K 1/187; G11B 19/2009

(57) ABSTRACT

There is provided a spindle motor including: a base member including an installation portion; and a stator core fixed to the installation portion, wherein the installation portion has a facing surface disposed so as to face a lower surface of a coreback of the stator core, and at least one of the facing surface and the lower surface of the coreback has a protrusion part formed thereon.

### CROSS-REFERENCE TO RELATED APPLICATION

This application claims the priority and benefit of Korean Patent Application No. 10-2014-0010056 filed on Jan. 28, 2014, with the Korean Intellectual Property Office, the disclosure of which is incorporated herein by reference.

### BACKGROUND

The present disclosure relates to a spindle motor and a recording disk drive including the same.

Generally, a three-phase brushless motor is used in a hard disk drive. Such a brushless motor includes a rotor using a shaft, a rotating member, as an axis, and a stator rotatably supporting the rotor.

In addition, the rotor may be provided with a magnet in which S and N poles are alternately magnetized in a circumferential direction.

Further, the stator includes an annular stator core formed by stacking several thin metal plates, wherein the stator core includes a plurality of teeth protruding in a radial direction at each phase position in the circumferential direction. Further, slots are formed by each of the teeth, and each of the teeth has coils corresponding thereto wound therearound.

In addition, when a varied three-phase motor current such as a sinusoidal wave current or a square wave current is supplied to the coils, the rotor is rotated, such that the brushless motor is driven.

However, when driving force is generated by electromagnetic interaction between the stator and the magnet, vibrations are generated together with the driving force.

These vibrations may be transferred to a head provided in the hard disk drive, reading data from and writing data to a disk. Therefore, an error may occur when the head reads data from and writes data to the disk.

Therefore, the development of a structure capable of reducing vibrations generated by the stator from passing through a base member and being transferred to the head is urgently required.

### RELATED ART DOCUMENT

(Patent Document 1) Japanese Patent Laid-Open Publication No. 1998-191605

### SUMMARY

An aspect of the present disclosure may provide a spindle motor capable of reducing a transfer of vibrations generated from a stator core, and a recording disk drive including the same.

According to an aspect of the present disclosure, a spindle motor may include: a base member including an installation portion; and a stator core fixed to the installation portion, wherein the installation portion has a facing surface disposed so as to face a lower surface of a coreback of the stator core, and at least one of the facing surface and the lower surface of the coreback has a protrusion part formed thereon.

A plurality of protrusion parts may be disposed so as to be spaced apart from each other in a circumferential direction.

The facing surface of the installation portion and the lower surface of the coreback may be disposed so as to be spaced apart from each other in regions except for the protrusion parts.

The number of protrusion parts may be at least three.

A space between the facing surface and the lower surface of the coreback may be filled with an adhesive.

According to another aspect of the present disclosure, a spindle motor may include: a base member including an installation portion; and a stator core fixed to the installation portion, wherein the installation portion has a facing surface disposed so as to face a lower surface of a coreback of the stator core, and the facing surface and the lower surface of the coreback are disposed so as to be spaced apart form each other in order to reduce a transfer of vibrations.

A space formed by the facing surface and the lower surface of the coreback may be filled with an adhesive.

According to another aspect of the present disclosure, a spindle motor may include: a pressed base molded using a steel sheet; an installation member fixed to the pressed base; and a stator core fixed to the installation member, wherein the installation member has a facing surface disposed so as to face a lower surface of a coreback of the stator core, and at least one of the facing surface and the lower surface of the coreback has a protrusion part formed thereon.

According to another aspect of the present disclosure, a hard disk drive may include: the spindle motor as described above; a head transfer part transferring a head reading data from and writing data to the recording disk mounted on the spindle motor to the recording disk; and an upper case coupled to the base member provided in the spindle motor so as to form an internal space accommodating the spindle motor and the head transfer part therein.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view showing a spindle motor according to a first exemplary embodiment of the present disclosure;

FIG. 2 is a partially enlarged view showing a base member and a stator core of the spindle motor according to a first exemplary embodiment of the present disclosure;

FIG. 3 is an enlarged view showing part A of FIG. 1;

FIG. 4 is an enlarged view showing part B of FIG. 1;

FIG. 5 is a schematic cross-sectional view showing a spindle motor according to a second exemplary embodiment of the present disclosure;

FIG. 6 is an enlarged view showing part C of FIG. 5;

FIG. 7 is a schematic cross-sectional view showing a spindle motor according to a third exemplary embodiment of the present disclosure;

FIG. 8 is an enlarged view showing part D of FIG. 7;

FIG. 9 is a schematic cross-sectional view showing a spindle motor according to a fourth exemplary embodiment of the present disclosure;

FIG. 10 is an enlarged view showing part E of FIG. 9;

FIG. 11 is a schematic cross-sectional view showing a spindle motor according to a fifth exemplary embodiment of the present disclosure;

FIG. 12 is an enlarged view showing part F of FIG. 11; and

FIG. 13 is a schematic cross-sectional view showing a recording disk drive according to a first exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

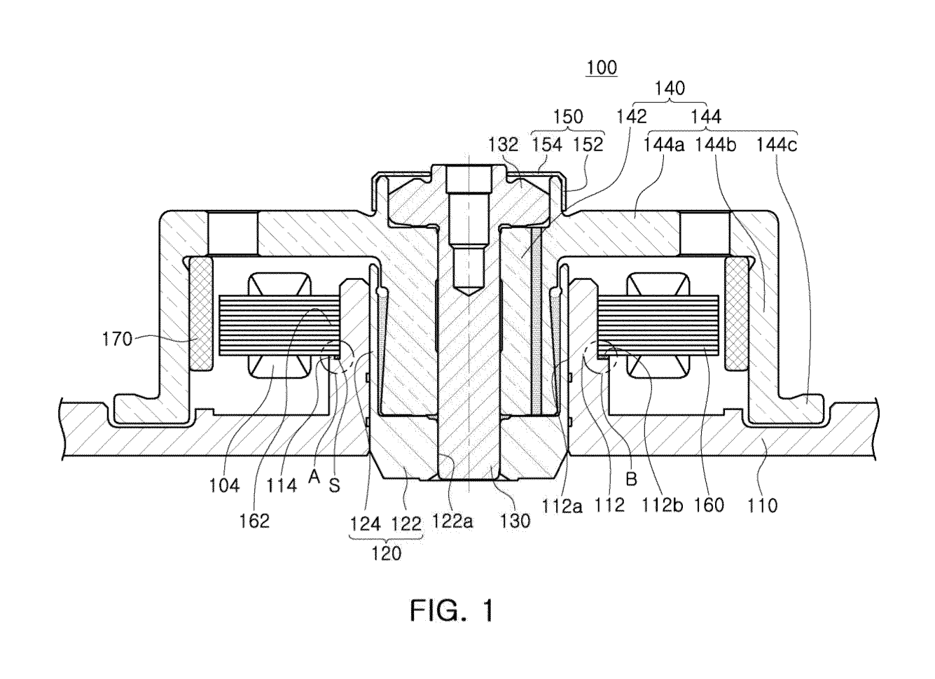

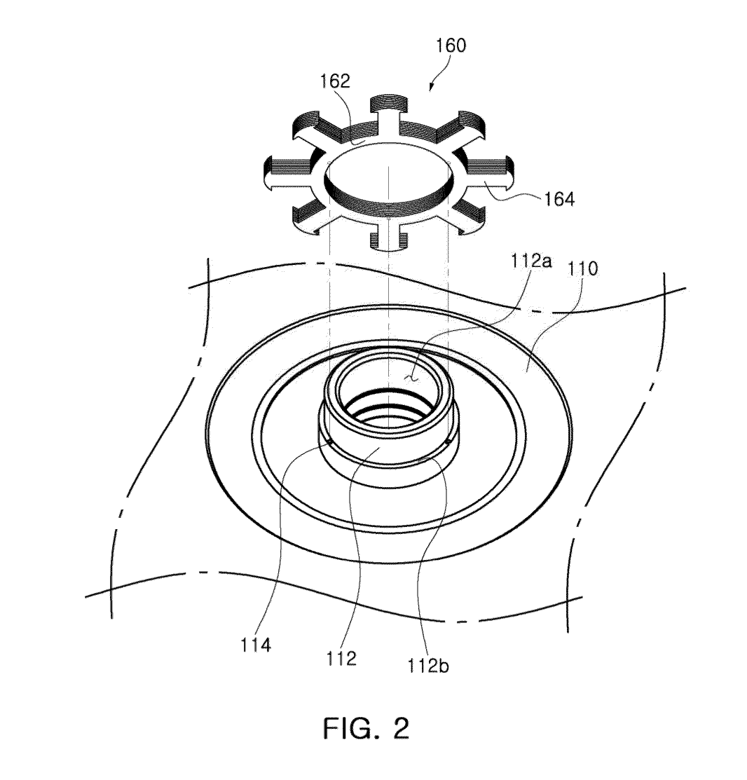

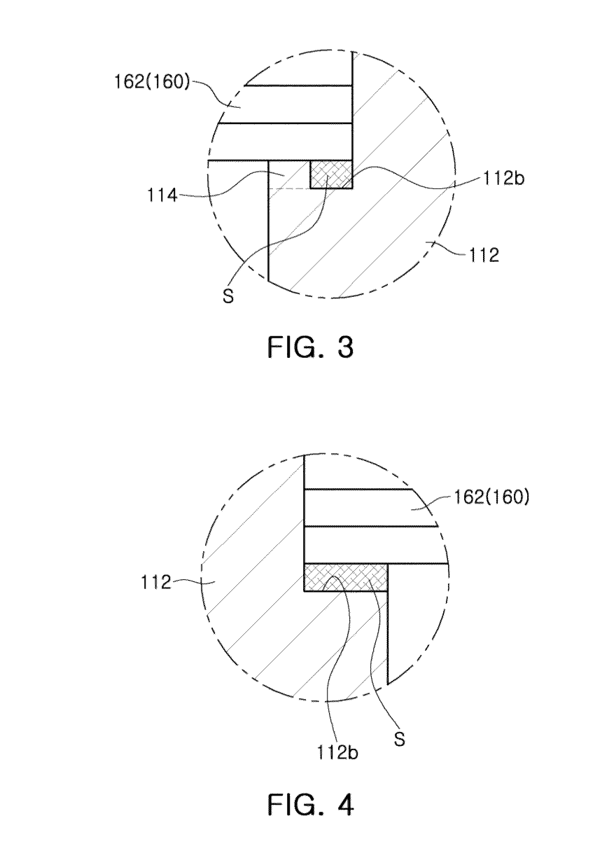

FIG. 1 is a schematic cross-sectional view showing a spindle motor according to a first exemplary embodiment of the present disclosure; FIG. 2 is a partially enlarged view showing a base member and a stator core of the spindle motor according to a first exemplary embodiment of the present disclosure; FIG. 3 is an enlarged view showing part A of FIG. 1; and FIG. 4 is an enlarged view showing part B of FIG. 1.

Referring to FIGS. 1 through 4, a spindle motor 100 according to a first exemplary embodiment of the present disclosure may include a base member 110, a lower thrust member 120, a shaft 130, a rotating member 140, a cap member 150, and a stator core 160 by way of example.

The base member 110 may include an installation portion 112. The installation portion 112 may be provided with an installation hole 112a into which the above-mentioned lower thrust member 120 is inserted and be extended in an upward axial direction.

Meanwhile, the installation portion 112 may have a facing surface 112b formed on an outer surface thereof, wherein the facing surface 112b is disposed so as to face a coreback 162 (See FIG. 2) of a stator core 160 to be described below. The facing surface 112b may be disposed so as to be spaced apart from a lower surface of the coreback 162 by a predetermined interval.

In addition, the facing surface 112b may be provided with protrusion parts 114 for supporting the lower surface of the coreback 162 of the stator core 160. A plurality of protrusion parts 114 may be disposed so as to be spaced apart from each other in a circumferential direction. That is, the protrusion parts 114 may serve to allow the facing surface 112b of the installation portion 112 and the lower surface of the coreback 162 to be disposed so as to be spaced apart from each other by a predetermined interval, and the lower surface of the coreback 162 may contact only the protrusion parts 114.

Meanwhile, as an example, at least three protrusion parts 114 may be formed. That is, the protrusion parts 114 may be disposed so as to be spaced apart from each other in the circumferential direction at an angle of 120 degrees therebetween.

As described above, a contact area between the coreback 162 of the stator core 160 and the facing surface 112b may be decreased by the protrusion parts 114, thereby reducing vibrations generated from the stator core 160 from being transferred to the base member 110.

Further, horizontality of the stator core 160 may be secured through the protrusion parts 114. In other words, a phenomenon that the stator core 160 is installed in a state in which it is inclined may be reduced.

In addition, as an example, a space between the facing surface 112b and the lower surface of the coreback 162 may be filled with an adhesive S. However, the present disclosure is not limited to the case in which the space between the facing surface 112b and the lower surface of the coreback 162 is filled with the adhesive S. That is, the adhesive S may be omitted.

The lower thrust member 120 may be inserted into the installation hole 112a of the installation portion 112, and may have an outer peripheral surface bonded to an inner peripheral surface of the installation portion 112. Here, the lower thrust member 120 may be fixed to the installation portion 122 by at least one of an adhering method, a press-fitting method, and a welding method.

Meanwhile, the lower thrust member 120 may include a disk part 122 having a disk shape and provided with a through-hole 122a into which a lower end portion of the shaft 130 is inserted and a sealing wall part 124 extended from an edge of the disk part 122 in the upward axial direction.

In addition, the lower thrust member 120 may form, together with a rotating member 140 to be described below, a bearing clearance in which a lubricating fluid is filled. Further, the sealing wall part 124 may serve to form, together with the rotating member 140, an interface (that is, a liquid-vapor interface) between the lubricating fluid and air.

The shaft 130 may have the lower end portion fixed to the lower thrust member 120 and include a flange part 132 formed at an upper end portion thereof. As an example, the lower end portion of the shaft 130 may be inserted into the through-hole 122a of the lower thrust member 120 to thereby be fixed to the lower thrust member 120. That is, the spindle motor 100 according to an exemplary embodiment of the present disclosure may have a fixed shaft structure in which the shaft 130 is fixed.

Meanwhile, the shaft 130 may also form, together with the rotating member 140, a bearing clearance in which the lubricating fluid is filled, and the flange part 132 of the shaft 130 may serve to form, together with the rotating member 140, a liquid-vapor interface.

The rotating member 140 may include a sleeve 142 forming, together with the lower thrust member 120 and the shaft 130, the bearing clearance, and a rotor hub 144 extended from the sleeve 142.

Here, terms with respect to directions will be defined. As viewed in FIG. 1, an axial direction refers to a vertical direction, that is, a direction from the lower end portion of the shaft 130 toward the upper end portion thereof or a direction from the upper end portion of the shaft 130 toward the lower end portion thereof, and a radial direction refers to a horizontal direction, that is, a direction from the shaft 130 toward an outer peripheral surface of the rotor hub 144 or from the outer peripheral surface of the rotor hub 144 toward shaft 130.

In addition, a circumferential direction refers to a rotation direction along an outer peripheral direction of the shaft 130.

The sleeve 142 may be disposed between the flange part 132 of the shaft 130 and the disk part 122 of the lower thrust member 120, and may form, together with the shaft 130 and the lower thrust member 120, the bearing clearance.

Meanwhile, upper and lower radial dynamic grooves (not shown) may be formed in at least one of an inner peripheral surface of the sleeve 142 and the outer peripheral surface of the shaft 130. The upper and lower radial dynamic grooves may be disposed so as to be spaced apart from each other by a predetermined interval in the axial direction, and may generate fluid dynamic pressure in the radial direction at the time of rotation of the sleeve 142. Therefore, the rotating member 140 may be more stably rotated.

The rotor hub 144 may be extended from the sleeve 142. Meanwhile, although the case in which the rotor hub 144 and the sleeve 142 are formed integrally with each other has been described by way of example in the present exemplary embodiment, the present disclosure is not limited thereto. That is, the rotor hub 144 and the sleeve 142 may be separately manufactured and be then coupled to each other.

Meanwhile, the rotor hub 144 may include a rotor hub body 144a having a disk shape, a magnet mounting part 144b extended from an edge of the rotor hub body 144a in a downward axial direction, and a disk supporting part 144c extended from a distal end of the magnet mounting part 144b in the radial direction.

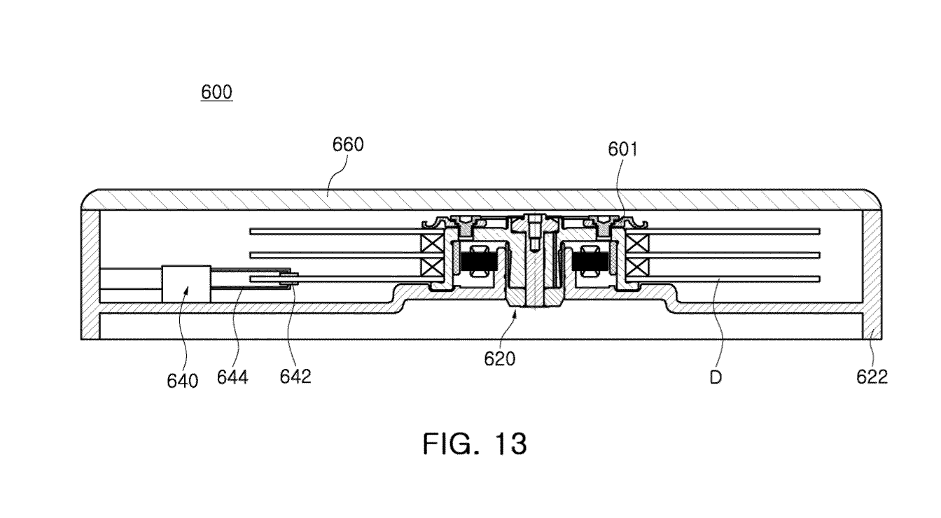

In addition, the rotor hub body 144a may have a clamp member 601 (See FIG. 13) fixed thereto.

In addition, the magnet mounting part 144b may include a driving magnet 170 fixedly installed on an inner surface thereof. Therefore, an inner surface of the driving magnet 170 may be disposed so as to face a front end of the stator core 160.

Meanwhile, the driving magnet 170 may be a permanent magnet generating magnetic force having a predetermined strength by alternately magnetizing an N pole and an S pole thereof in the circumferential direction.

Here, a rotational driving scheme of the rotating member 140 will be briefly described. When power is supplied to a coil 104 wound around the stator core 160, driving force capable of rotating the rotating member 140 may be generated by an electromagnetic interaction between the stator core 160 having the coil 104 wound therearound and the driving magnet 170 to rotate the rotating member 140.

That is, the driving magnet 170 and the stator core 160 disposed so as to face the driving magnet 170 and having the coil 104 wound therearound may electromagnetically interact with each other to rotate the rotating member 140.

Vibrations may be generated from the stator core 160 due to the electromagnetic interaction as described above, and be transferred to the base member 110.

The cap member 150 may be fixed to the rotor hub 144 to prevent leakage of the lubricating fluid. Meanwhile, the cap member 150 may include a bonded part 152 having an inner peripheral surface bonded to the outer peripheral surface of the rotor hub 144 and a cover part 154 bent from the bonded part 152 in an inner diameter direction.

That is, in the case in which the bonded part 152 of the cap member 150 is bonded to the rotor hub 144, the cover part 154 may be disposed over the flange part 132 of the shaft 130 to prevent the leakage of the lubricating fluid.

Meanwhile, the cap member 150 is not a necessary component of the spindle motor 100 according to an exemplary embodiment of the present disclosure. Therefore, the cap member 150 may be omitted. In other words, the cap member 150 may not be included in the spindle motor 100 according to an exemplary embodiment of the present disclosure.

The stator core 160 may be fixed to the installation portion 112. Meanwhile, the stator core 160 may include the coreback 162 (See FIG. 2) having a circular ring shape and a plurality of teeth parts 164 extended from the coreback 162 in the radial direction.

Meanwhile, in the case in which the stator core 160 is installed on the installation portion 112, an inner peripheral surface of the coreback 162 of the stator core 160 may contact the outer surface of the installation portion 112, and the lower surface of the coreback 162 may be disposed so as to be spaced apart from the facing surface 112b of the installation portion 112.

Here, the lower surface of the coreback 162 may contact the protrusion parts 114 protruding from the facing surface 112b.

Meanwhile, the stator core 160 may be installed on the installation portion 112 by at least one of an adhering method and a press-fitting method. In the case in which the stator core 160 and the installation portion 112 are bonded to each other by the adhesive S, the space formed by the lower surface of the coreback 162 and the facing surface 112b may be filled with the adhesive S.

As described above, the contact area between the lower surface of the coreback 162 of the stator core 160 and the facing surface 112b formed on the installation portion 112 of the base member 110 may be significantly decreased through the protrusion parts 114.

Therefore, a transfer of vibrations in the axial direction among the vibrations transferred from the stator core 160 may be reduced.

Hereinafter, a spindle motor according to a second exemplary embodiment of the present disclosure will be described with reference to the accompanying drawings. However, the same components as the above-mentioned components will be denoted by the same reference numerals, and a detailed description therefor will be omitted.

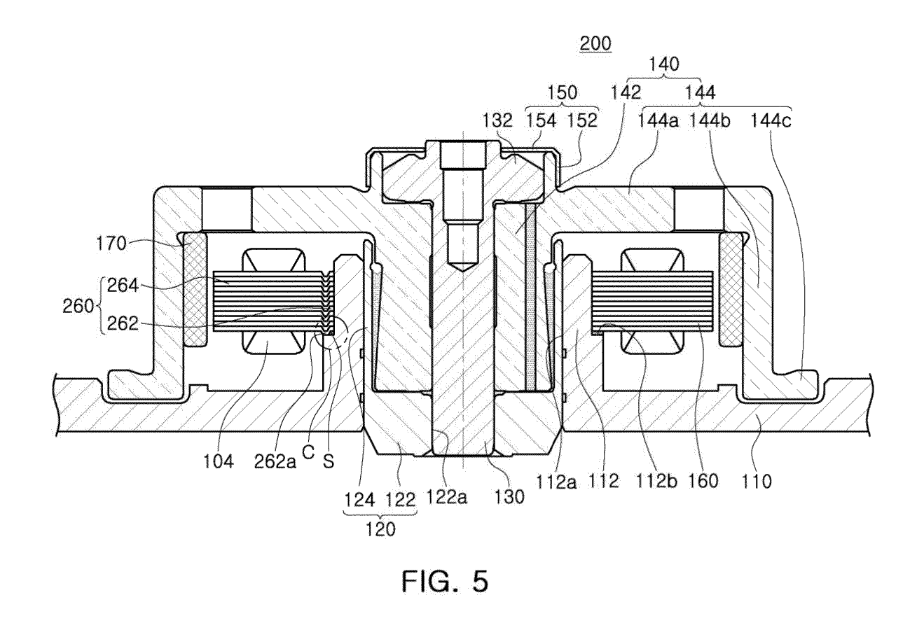

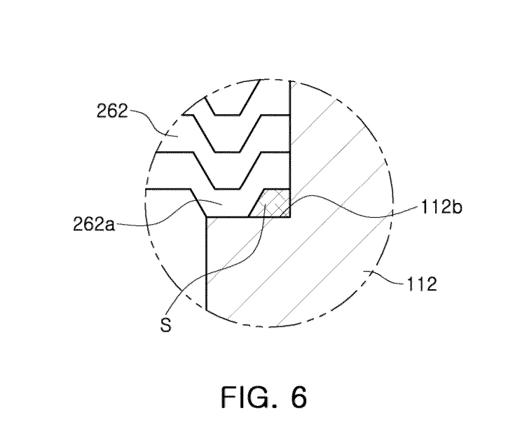

FIG. 5 is a schematic cross-sectional view showing a spindle motor according to a second exemplary embodiment of the present disclosure; and FIG. 6 is an enlarged view showing part C of FIG. 5.

Referring to FIGS. 5 and 6, a stator core 260 may be fixed to the installation portion 112. Meanwhile, the stator core 260 may include a coreback 262 having a circular ring shape and a plurality of teeth parts 264 extended from the coreback 262 in the radial direction.

Meanwhile, the coreback 262 may have protrusion parts 262 protruding from a lower surface thereof. In addition, a plurality of protrusion parts 262a may be disposed so as to be spaced apart from each other in the circumferential direction.

Further, in the case in which the stator core 260 is installed on the installation portion 112, an inner peripheral surface of the coreback 262 of the stator core 260 may contact the outer surface of the installation portion 112, and the lower surface of the coreback 262 may be disposed so as to be spaced apart from the facing surface 112b of the installation portion 112.

Here, the protrusion parts 262a protruding from the lower surface of the coreback 262 may contact the facing surface 112b of the installation portion 112.

Meanwhile, the stator core 260 may be installed on the installation portion 112 by at least one of an adhering method and a press-fitting method. In the case in which the stator core 260 and the installation portion 112 are bonded to each other by the adhesive S, a space formed by the lower surface of the coreback 262 and the facing surface 112b may be filled with the adhesive S.

As described above, a contact area between the lower surface of the coreback 262 of the stator core 260 and the facing surface 112b formed on the installation portion 112 of the base member 110 may be significantly decreased through the protrusion parts 262a.

Therefore, a transfer of vibrations in the axial direction among the vibrations transferred from the stator core 260 may be reduced.

Hereinafter, a spindle motor according to a third exemplary embodiment of the present disclosure will be described with reference to the accompanying drawings. However, the same components as the above-mentioned components will be denoted by the same reference numerals, and a detailed description therefor will be omitted.

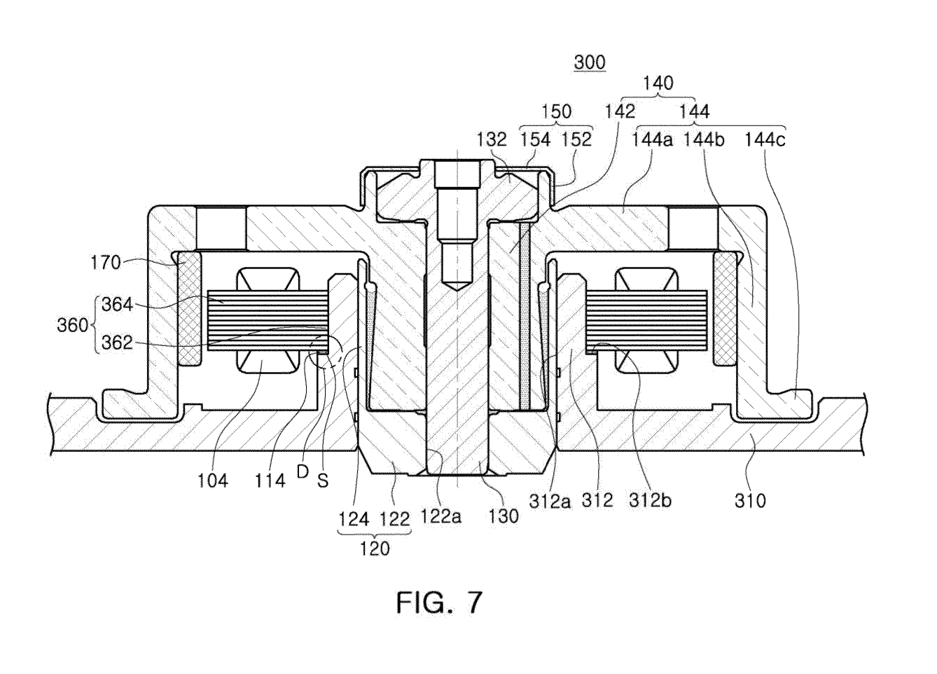

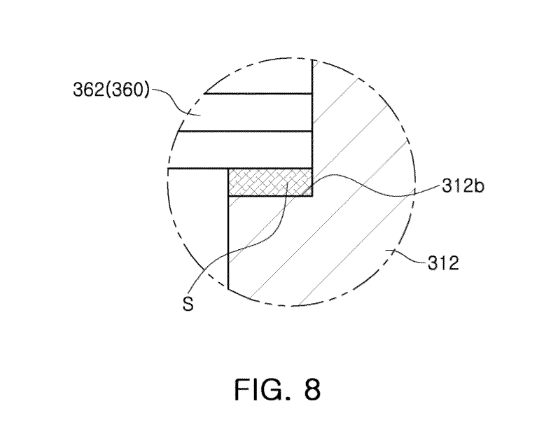

FIG. 7 is a schematic cross-sectional view showing a spindle motor according to a third exemplary embodiment of the present disclosure; and FIG. 8 is an enlarged view showing part D of FIG. 7.

Referring to FIGS. 7 and 8, a base member 310 may have an installation portion 312. In addition, the installation portion 312 may have a facing surface 312b disposed so as to face a lower surface of a coreback 362 of a stator core 360.

Meanwhile, the facing surface 312b of the installation portion 312 and the lower surface of the coreback 362 may be disposed so as to be spaced apart from each other by a predetermined interval.

In addition, a space formed by the facing surface 312b of the installation portion 312 and the lower surface of the coreback 362 may be filled with the adhesive S.

As described above, the lower surface of the coreback 362 and the facing surface 312b of the installation portion 312 may be disposed so as to be spaced apart from each other by the predetermined interval, such that a transfer of vibrations in the axial direction among the vibrations transferred from the stator core 360 may be reduced.

Hereinafter, a spindle motor according to a fourth exemplary embodiment of the present disclosure will be described with reference to the accompanying drawings. However, the same components as the above-mentioned components will be denoted by the same reference numerals, and a detailed description therefor will be omitted.

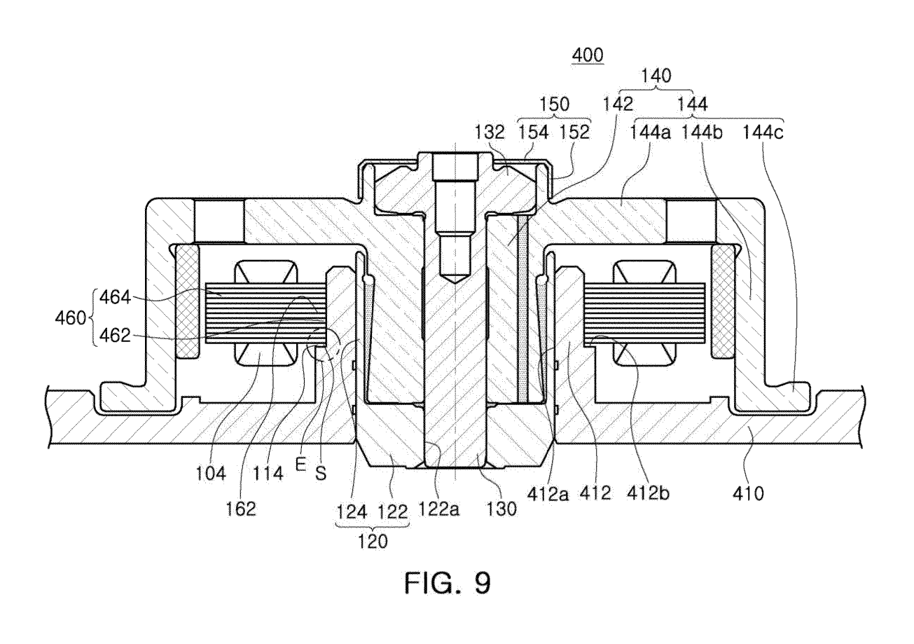

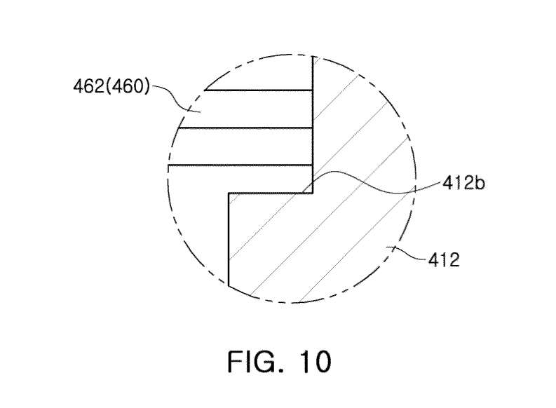

FIG. 9 is a schematic cross-sectional view showing a spindle motor according to a fourth exemplary embodiment of the present disclosure; and FIG. 10 is an enlarged view showing part E of FIG. 9.

Referring to FIGS. 9 and 10, a base member 410 may have an installation portion 412. In addition, the installation portion 412 may have a facing surface 412b disposed so as to face a lower surface of a coreback 462 of a stator core 460.

Meanwhile, the facing surface 412b of the installation portion 412 and the lower surface of the coreback 462 may be disposed so as to be spaced apart from each other by a predetermined interval.

In addition, the stator core 460 may be installed on the installation portion 412 of the base member 410 by a press-fitting method. Therefore, a space formed by the lower surface of the coreback 462 and the facing surface 412b of the installation portion 412 may not be filled with the adhesive.

As described above, the lower surface of the coreback 462 and the facing surface 412b of the installation portion 412 may be disposed so as to be spaced apart from each other by the predetermined interval and the adhesive may not be filled, such that a transfer of vibrations in the axial direction among the vibrations transferred from the stator core 460 may be reduced.

Hereinafter, a spindle motor according to a fifth exemplary embodiment of the present disclosure will be described with reference to the accompanying drawings. However, the same components as the above-mentioned components will be denoted by the same reference numerals, and a detailed description therefor will be omitted.

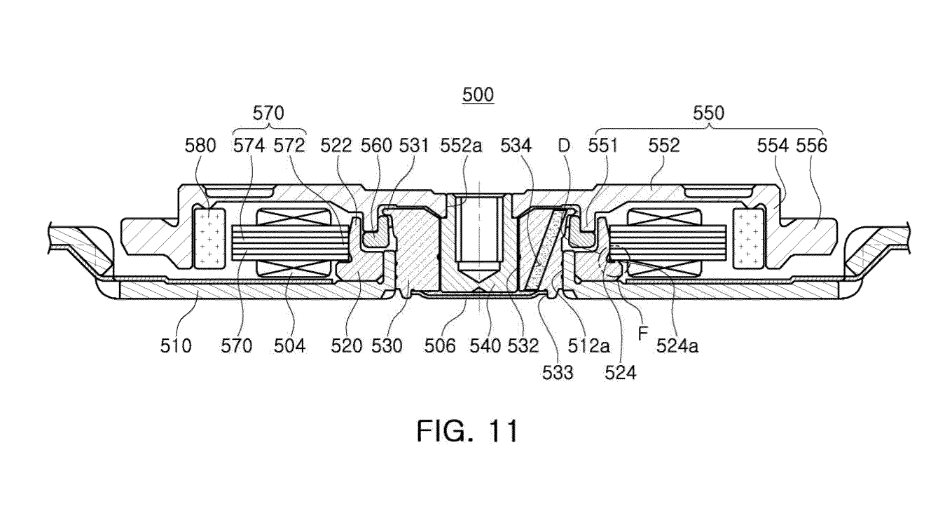

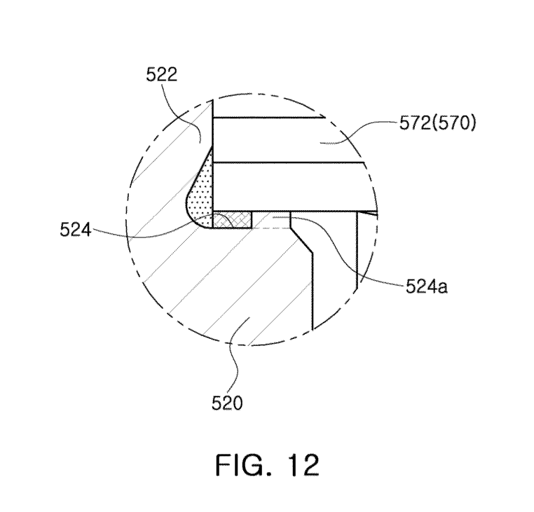

FIG. 11 is a schematic cross-sectional view showing a spindle motor according to a fifth exemplary embodiment of the present disclosure; and FIG. 12 is an enlarged view showing part F of FIG. 11.

Referring to FIGS. 11 and 12, a spindle motor 500 according to another exemplary embodiment of the present disclosure may include a base member 510, an installation member 520, a sleeve 530, a shaft 540, a rotor hub 550, a stopper member 560, and a stator core 570 by way of example.

The base member 510 may include an installation portion 512 having an installation hole 512a formed therein. The installation portion 512 may be extended in the upward axial direction, and may have the sleeve 530 inserted into the installation hole 512a.

Meanwhile, the base member 510 may be formed by plastic working. For example, a steel plate may be subjected to press working to mold the base member 510.

The installation member 520 may be fixed to the base member 510 so as to be disposed at an outer portion of the installation portion 512 in the radial direction. That is, an inner peripheral surface of the installation member 520 may be bonded to an outer peripheral surface of the installation portion 512, and a lower surface of the installation member 520 may be bonded to an upper surface of the base member 510.

Meanwhile, the installation member 520 may be provided with a protruding wall body 522 to which an inner surface of the stator core 570 is bonded, and the protruding wall body 522 may have a facing surface 524 formed at a lower portion thereof, wherein the facing surface 524 is disposed so as to face a lower surface of a coreback 572 of the stator core 570.

Meanwhile, the facing surface 524 may have protrusion parts 524a protruding therefrom in the axial direction. A plurality of protrusion parts 524a may be disposed so as to be spaced apart from each other in the circumferential direction. In addition, the protrusion parts 524a may serve to allow the facing surface 524 of the installation member 520 and the lower surface of the coreback 572 to be disposed so as to be spaced apart from each other by a predetermined interval, and the lower surface of the coreback 572 may contact only the protrusion parts 524a.

Meanwhile, as an example, at least three protrusion parts 524a may be formed and may be disposed so as to be spaced apart from each other in the circumferential direction at an angle of 120 degrees therebetween.

As described above, a contact area between the coreback 572 of the stator core 570 and the facing surface 524 may be decreased by the protrusion parts 524a, thereby reducing a transfer of vibration components in the axial direction among vibrations generated from the stator core 570.

In addition, as an example, a space between the facing surface 524 and the lower surface of the coreback 572 may be filled with the adhesive S. However, the space between the facing surface 524 and the lower surface of the coreback 572 may not be filled with the adhesive S.

The sleeve 530 may be fixed to the base member 510. That is, as described above, a lower end portion of the sleeve 530 may be bonded to the installation portion 512 of the base member 510 by at least one of an adhesive, a press-fitting method, and a welding method.

In addition, the sleeve 530 may have a protrusion part 531 formed at an upper end portion thereof and protruding in the radial direction. In other words, the protrusion part 531 may be formed at the upper end portion of the sleeve 530 in order to prevent, together with the stopper member 560, the rotor hub 550 from being excessively floated.

In addition, the sleeve 530 may be provided with a shaft hole 532 into which the shaft 540 is inserted, and the shaft 540 may be inserted into the shaft hole 532 to form, together with the sleeve 530, a bearing clearance filled with the lubricating fluid.

In addition, the sleeve 530 may have upper and lower radial dynamic grooves (not shown) formed in an inner surface thereof in order to generate fluid dynamic pressure by pumping the lubricating fluid filled in the above-mentioned bearing clearance.

Meanwhile, the sleeve 530 may have a cover member 506 installed at the lower end portion thereof in order to prevent the lubricating fluid filled in the above-mentioned bearing clearance from being leaked downwardly. To this end, the sleeve 530 may include a depression groove 533 formed in the lower end portion thereof.

In addition, the sleeve 530 may have a circulating hole 534 formed therein in order to circulate the lubricating fluid. The circulating hole 534 may serve to smoothly discharge air bubbles to the outside simultaneously with serving to reduce generation of negative pressure. Meanwhile, the circulating hole 534 may be inclined.

The shaft 540 may be inserted into the sleeve 530 and be rotated together with the rotor hub 550. Meanwhile, in the case in which the shaft 540 is inserted into the shaft hole 532 of the sleeve 530, an upper end portion of the shaft 540 may protrude from the sleeve 530. In addition, the rotor hub 550 may be fixed to the upper end portion of the shaft 540 protruding from the sleeve 530.

The rotor hub 550 may be fixed to the shaft 540, and may include an extension wall part 551 extended so as to be disposed at an outer portion of the sleeve 530 in the radial direction.

Meanwhile, the rotor hub 550 may include a body 552 provided with an insertion hole 552a into which the shaft 540 is inserted and having a disk shape, a magnet mounting part 554 extended from an edge of the body 552 in the downward axial direction, and a disk supporting part 556 extended from the magnet mounting part 554 in the radial direction.

In addition, the above-mentioned extension wall part 551 may be extended from a lower surface of the body 552 in the downward axial direction so as to be disposed at the outer portion of the sleeve 530 in the radial direction.

In addition, the magnet mounting part 554 may have a driving magnet 580 fixedly installed on an inner surface thereof, and an inner surface of the driving magnet 580 may be disposed so as to face a front end of the stator core 570.

In addition, the driving magnet 580 may be a permanent magnet generating magnetic force having a predetermined strength by alternately magnetizing an N pole and an S pole thereof in the circumferential direction.

Here, a rotational driving scheme of the rotor hub 550 will be briefly described. When power is supplied to a coil 504 wound around the stator core 570, driving force rotating the rotor hub 550 may be generated by an electromagnetic interaction between the stator core 570 having the coil 504 wound therearound and the driving magnet 580 to rotate the rotor hub 550.

That is, the driving magnet 580 and the stator core 570 disposed so as to face the driving magnet 580 and having the coil 504 wound therearound may electromagnetically interact with each other to rotate the rotor hub 550.

Vibrations may be generated from the stator core 570 due to the electromagnetic interaction as described above, and be transferred to the base member 510.

The stopper member 560 may be fixed to an inner surface of the extension wall part 551, and may serve to prevent the rotor hub 550 from being excessively floated or being separated.

In addition, at least one of the inner surface of the extension wall part 551 and an outer surface of the stopper member 560 may have one or more step.

As described above, a contact area between the lower surface of the coreback 572 of the stator core 570 and the facing surface 524 of the installation member 520 may be significantly decreased through the protrusion parts 524a.

Therefore, a transfer of vibrations in the axial direction among the vibrations transferred from the stator core 570 may be reduced.

Hereinafter, a recording disk drive according to an exemplary embodiment of the present disclosure will be described with reference to the accompanying drawings.

FIG. 13 is a schematic cross-sectional view showing a recording disk drive according to a first exemplary embodiment of the present disclosure.

Referring to FIG. 13, the recording disk driving device 600 according to an exemplary embodiment of the present disclosure may be a hard disk drive, and may include a spindle motor 620, a head transfer part 640, and an upper case 660.

The spindle motor 620 may be any one of the spindle motors according to first to fifth exemplary embodiments of the present disclosure described above, and may have a recording disk D mounted thereon.

The head transfer part 640 may transfer a head 642 reading data from and writing data to the recording disk D mounted on the spindle motor 620 to a surface of the recording disk D of which the information is to be detected. The head 642 may be disposed on a support part 644 of the head transfer part 640.

The upper case 660 may be coupled to a base member 622 in order to form an internal space accommodating the spindle motor 620 and the head transfer part 640 therein.

As set forth above, according to exemplary embodiments of the present disclosure, the transfer of the vibrations generated from the stator core may be reduced through the protrusion parts.

In addition, the horizontality of the stator core may be secured through the protrusion parts.

While exemplary embodiments have been shown and described above, it will be apparent to those skilled in the art that modifications and variations could be made without departing from the scope of the present invention as defined by the appended claims.

What is claimed is:

1. A spindle motor comprising:
a base member including an installation portion; and
a stator core fixed to the installation portion,
wherein the installation portion has a facing surface disposed so as to face a lower surface of a coreback of the stator core, and
at least one of the facing surface and the lower surface of the coreback has a protrusion part formed thereon.

2. The spindle motor of claim 1, wherein a plurality of protrusion parts are disposed so as to be spaced apart from each other in a circumferential direction.

3. The spindle motor of claim 2, wherein the facing surface of the installation portion and the lower surface of the coreback are disposed so as to be spaced apart from each other in regions except for the protrusion parts.

4. The spindle motor of claim 2, wherein the number of protrusion parts is at least three.

5. The spindle motor of claim 3, wherein a space between the facing surface and the lower surface of the coreback is filled with an adhesive.

6. A spindle motor comprising:
a base member including an installation portion; and
a stator core fixed to the installation portion,
wherein the installation portion has a facing surface disposed so as to face a lower surface of a coreback of the stator core, and
the facing surface and the lower surface of the coreback are disposed so as to be spaced apart form each other in order to reduce a transfer of vibrations.

7. The spindle motor of claim 6, wherein a space formed by the facing surface and the lower surface of the coreback is filled with an adhesive.

8. A spindle motor comprising:
a pressed base molded using a steel sheet;
an installation member fixed to the pressed base; and
a stator core fixed to the installation member,
wherein the installation member has a facing surface disposed so as to face a lower surface of a coreback of the stator core, and
at least one of the facing surface and the lower surface of the coreback has a protrusion part formed thereon.

9. The spindle motor of claim 8, wherein a plurality of protrusion parts are disposed so as to be spaced apart from each other in a circumferential direction.

10. The spindle motor of claim 9, wherein the facing surface of the installation member and the lower surface of the coreback are disposed so as to be spaced apart from each other in regions except for the protrusion parts.

11. The spindle motor of claim 9, wherein the number of protrusion parts is at least three.

12. The spindle motor of claim 9, wherein a space between the facing surface and the lower surface of the coreback is filled with an adhesive.

13. A hard disk drive comprising:
the spindle motor of claim 1 rotating a recording disk;
a head transfer part transferring a head reading data from and writing data to the recording disk mounted on the spindle motor to the recording disk; and
an upper case coupled to the base member provided in the spindle motor so as to form an internal space accommodating the spindle motor and the head transfer part therein.
